(19) United States
(12) Patent Application Publication
(10) Pub. No.: US 2026/0070676 A1
(43) Pub. Date: Mar. 12, 2026

(54) MONOLITHIC AUTONOMOUS ORBITAL VEHICLE WITH HYBRID ADAPTIVE DISTURBANCE COMPENSATION

(71) Applicant: Richard Joseph Mitchell, TAVARES, FL (US)

(72) Inventor: Richard Joseph Mitchell, TAVARES, FL (US)

(21) Appl. No.: 19/387,593

(22) Filed: Nov. 12, 2025

(51) Int. Cl. B64G 1/24; B25J 9/16; B64G 1/36; G05B 23/02

(52) U.S. Cl. CPC B64G 1/247; B25J 9/161; B25J 9/163; B25J 9/1664; B64G 1/36; G05B 23/0283

(57) ABSTRACT

A system and method for a monolithic autonomous orbital vehicle enables proactive, integrated self-maintenance. A novel hybrid dual-loop control architecture provides robust stability against both predictable and unmodeled disturbances (e.g., propellant slosh). A baseline feed-forward loop cancels predictable disturbances from robotic motion. Concurrently, an adaptive feed-forward loop processes a “residual attitude error” using a prognostic-informed module, such as a Model Predictive Control (MPC) optimizer or Reinforcement Learning (RL) policy. This module receives Remaining Useful Life (RUL) estimates from a health system that detects incipient faults. The module generates a holistically optimized corrective command. A final combined command, summing the baseline and corrective commands, ensures high-precision stability during self-repair by simultaneously satisfying dynamic, health-informed constraints based on the RUL estimates.

### BACKGROUND OF THE INVENTION

### 1. Technical Field

The present disclosure relates generally to the field of autonomous space systems and, more specifically, to a system and method for enabling a single, monolithic orbital vehicle to perform physical self-repair of its own hardware components while maintaining high-precision attitude stability.

### 2. Background Art

High-value space assets, such as geosynchronous communications satellites and deep-space probes, are engineered for high reliability. However, a permanent failure of a critical hardware component, such as a reaction wheel or flight computer, can prematurely terminate a mission, resulting in the total loss of the asset.

The field of on-orbit servicing (OOS) has emerged to address this limitation. Historically, this field has been dominated by a “servicer-client” paradigm, wherein a dedicated “servicer” spacecraft (e.g., DARPA's Orbital Express, NASA's OSAM-1, and commercial vehicles) is launched to rendezvous with and repair a separate “client” satellite. This paradigm, while functional, introduces significant operational risks and costs associated with autonomous rendezvous, docking, and proximity operations.

An alternative architecture, and the subject of the present invention, is a “monolithic” vehicle that integrates all necessary self-repair capabilities, including robotic manipulators and spare component storage, onto a single spacecraft bus. This approach eliminates the risks of inter-spacecraft operations and is particularly advantageous for deep-space missions where external servicing is impossible.

However, both the servicer-client paradigm and the monolithic paradigm share a formidable and unsolved technical challenge: maintaining high-precision attitude stability while performing robotic manipulation on a free-floating platform. The motion of the robotic manipulator induces significant and complex disturbance forces and torques on the spacecraft bus. A conventional feedback-only attitude control system (ACS), such as a PID controller, is inadequate as it can only react to a measured attitude error after the disturbance has already occurred, leading to pointing errors that are unacceptable for precision tasks.

The prior art has proposed a partial solution known as feed-forward control. In this approach, a predictive model of the manipulator's known dynamics (a kinodynamic model) is used to calculate the expected disturbance torque.

This predicted torque is then “fed forward” to the ACS actuators to generate a counter-torque, canceling the known disturbance as it happens.

While this static feed-forward approach can cancel the primary disturbances from the manipulator's own motion, it is critically insufficient for high-precision self-repair.

It fails to address a second, more complex class of disturbances: unmodeled and time-varying disturbances. These include, but are not limited to, the significant and unpredictable forces from propellant “slosh” within the vehicle's tanks, thermal deformation and structural flexion in the bus and manipulator, and the complex, time-varying shift in the entire system's center of mass and inertia tensor as a heavy hardware component (e.g., a replacement reaction wheel) is detached and moved across the spacecraft.

Therefore, there exists a clear and unmet need for an advanced control architecture that can stabilize a monolithic self-repairing vehicle by compensating for both the predictable kinodynamic disturbances and the unpredictable, unmodeled, time-varying disturbances (like propellant slosh) in real-time.

### BRIEF SUMMARY OF THE INVENTION

The present invention provides a system and method for a monolithic autonomous orbital vehicle that solves the aforementioned stability problem by implementing a novel, hybrid dual-loop control architecture. This architecture provides unprecedented attitude stability, enabling proactive, high-precision robotic self-maintenance and repair.

The invention's control system departs from the simple, static feed-forward models of the prior art. Instead, it utilizes two distinct, synergistic control loops:

A Baseline Feed-Forward Loop: This first loop uses a conventional kinodynamic model of the manipulator to generate a baseline feed-forward command.
1. This command is calculated to cancel the known, predictable disturbance torques generated by the manipulator's planned motion, as understood by the prior art.
2. An Adaptive Feed-Forward Loop: This second, more advanced loop comprises a real-time, adaptive disturbance and health management module. This module actively monitors the vehicle's sensor suite during the robotic motion to identify residual attitude errors—the errors not predicted by the baseline model. These residual errors are processed to identify the unmodeled disturbances (e.g., from propellant slosh or structural flex). This module, or a coupled prognostic module, is also configured to detect incipient faults in vehicle components prior to failure, generating a Remaining Useful Life (RUL) estimate. The adaptive module then generates a corrective feed-forward command to cancel these unmodeled disturbances in real-time.

The final command sent to the attitude control actuators is a holistically optimized command, representing the sum of the baseline command (for known disturbances) and the corrective command (for unmodeled disturbances).

This hybrid, dual-loop approach allows the system to proactively cancel all significant disturbances, achieving a level of precision and stability not possible with any single-loop controller, while simultaneously managing the long-term health of the vehicle by optimizing its actions based on the RUL of its own components.

In various embodiments, the adaptive disturbance and health management module may be implemented using advanced control strategies, such as a Prognostic-Informed Model Predictive Control (MPC) optimizer or a trained Prognostic-Informed Deep Reinforcement Learning (RL) policy, which are uniquely suited to solving such complex, real-time estimation and multi-objective control problems.

### BRIEF DESCRIPTION OF THE SEVERAL VIEWS OF THE DRAWING

FIG. 1 is a block diagram illustrating the overall system architecture of the self-repairing autonomous orbital vehicle.

FIG. 2 is a block diagram illustrating the functional components and data flow of the intelligent decision-making module, including the hybrid control planners.

FIG. 3 is a flow diagram illustrating the logical steps of the end-to-end autonomous orbital self-repair protocol.

FIG. 4 is a perspective view of an exemplary embodiment of the system on a geosynchronous communications satellite.

FIG. 5 is a block diagram illustrating an exemplary embodiment of the Intelligent Decision-Making Module wherein the adaptive disturbance estimation loop is implemented using a Prognostic-Informed Model Predictive Control (MPC) architecture.

FIG. 6 is a block diagram illustrating an exemplary embodiment of the Intelligent Decision-Making Module wherein the adaptive disturbance estimation loop is implemented using a Prognostic-Informed Deep Reinforcement Learning (RL) architecture.

FIG. 7 is a vector diagram illustrating the disturbance torque and the counteracting feed-forward control torque.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

### System Architecture

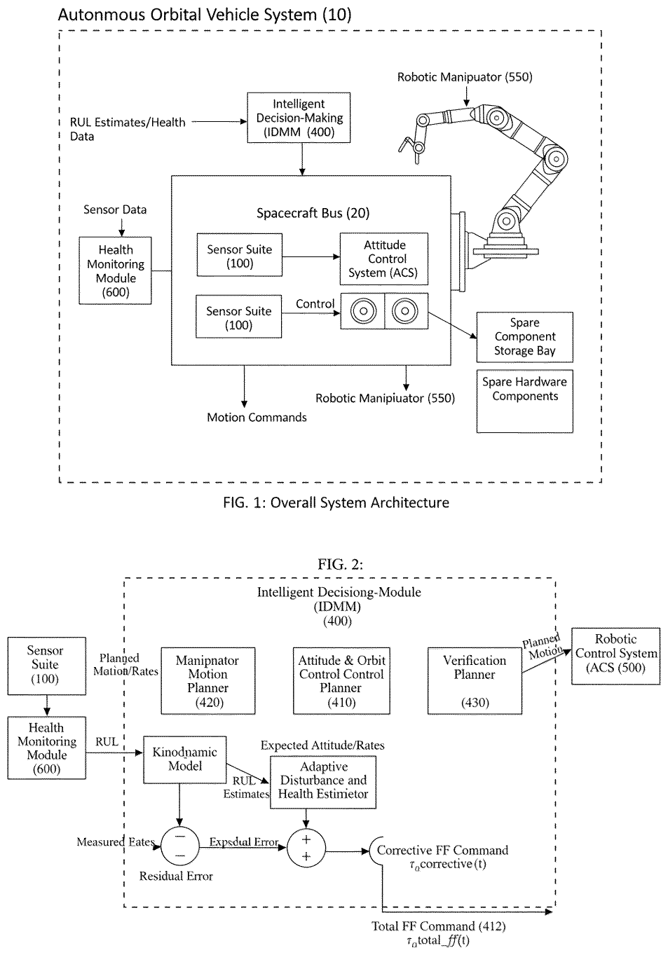

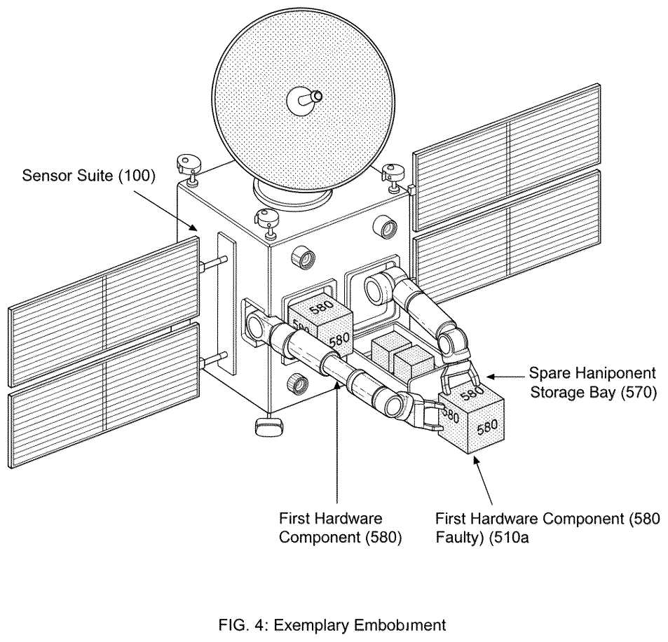

Referring to FIG. 1 and FIG. 4, the architecture is embodied in an autonomous orbital vehicle system (10). The system (10) comprises a Spacecraft Bus (20), an Attitude Determination and Control Sensor Suite (100), a Health Monitoring Module (600), an Attitude Control System (ACS) (500), at least one Robotic Manipulator (550), a Spare Component Storage Bay (570), and an Intelligent Decision-Making Module (400).

The Health Monitoring Module (600), which may also be termed a prognostics and health management module, is configured to continuously assess the operational status of system components, such as a reaction wheel assembly (510a), and, upon detecting an incipient fault prior to an unrecoverable failure, generate a structured prognostic fault signature. This structured prognostic fault signature includes not only a fault type but also a quantitative prognostic estimate of a future failure time, such as a Remaining Useful Life (RUL) estimate.

The ACS (500) comprises actuators, such as reaction wheels (510), to control the orientation of the bus (20). The Spare Component Storage Bay (570) houses spare hardware components (580) designed as Orbit Replaceable Units (ORUs).

The Intelligent Decision-Making Module (400) serves as the cognitive core, configured to receive the structured prognostic fault signature and autonomously plan and execute the self-maintenance or repair protocol, scheduling the intervention at an optimal time based on the RUL estimate.

### Hybrid Disturbance-Compensated Control Architecture

The core innovation of the present invention resides within The Intelligent Decision-Making Module (400), and its method for maintaining high-precision attitude control. This is achieved via a hybrid, dual-loop control scheme, as illustrated in the data flow of FIG. 2.

The problem is that a simple kinodynamic model of the manipulator is insufficient. It cannot account for unmodeled, time-varying disturbances, such as propellant slosh, structural flexion, or the significant shift in the vehicle's center of mass and inertia tensor that occurs as the manipulator (550) moves a heavy ORU (580) from the storage bay (570) to its installation port (e.g., replacing 510a).

The inventive architecture solves this by separating the problem into two parts:
1. Baseline Feed-Forward Loop (for Known Disturbances): The Manipulator Motion Planner (420) generates a planned motion q (t) for the manipulator. This planner, or a coupled module, uses a known kinodynamic model of the manipulator and bus to compute a baseline feed-forward command (part of 412), τ_{baseline}(t). This command profile is designed to counteract the predictable disturbance torques (424) that will be induced by the arm's motion. This step is conventional.
2. Adaptive Feed-Forward Loop (for Unmodeled Disturbances): A second, parallel control loop is executed by an Adaptive Disturbance and Health Estimator (conceptually within the Attitude & Orbit Control Planner 410). This estimator receives a real-time data stream from the Sensor Suite (100) during the execution of the motion. It compares the vehicle's actual attitude and angular rates to the expected attitude and rates (which are based on the baseline model). The difference between the actual and expected state is the residual error, which is attributable to the unmodeled disturbances (slosh, flex, etc.). The Adaptive Disturbance and Health Estimator processes this residual error signal to generate a corrective feed-forward command, τ_{corrective}(t), which is specifically calculated to cancel these unmodeled disturbances. Concurrently, this module processes the RUL estimates from the Health Monitoring Module (600) to ensure the generated commands are not only stable but also preserve the long-term health of the vehicle's components.

The Attitude & Orbit Control Planner (410) holistically optimizes and combines these commands and sends a total feed-forward command, τ_{total_ff}(t)=τ_{baseline}(t)+τ_{corrective}(t), to the ACS (500). A standard feedback controller (e.g., PID) may run concurrently to eliminate any final, minor residuals. This dual-loop hybrid architecture ensures that both predictable and unpredictable disturbances are actively canceled, providing robust stability.

### Exemplary Embodiments of the Adaptive Disturbance Estimator

### A. Implementation via Prognostic-Informed Model Predictive Control (MPC)

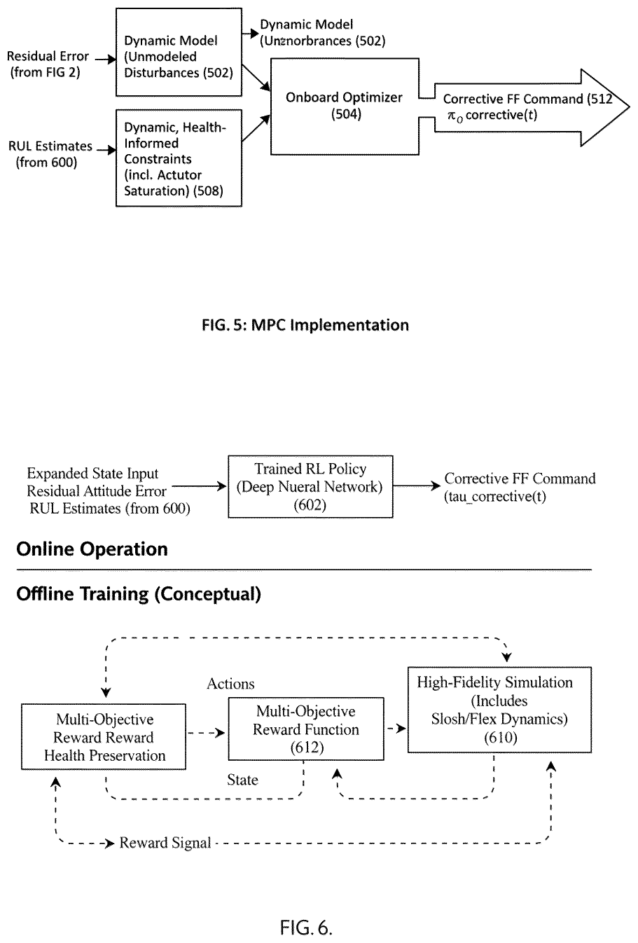

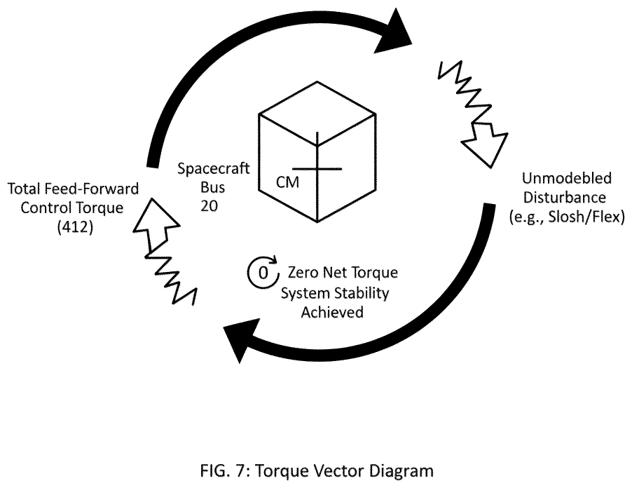

Referring to FIG. 5, in one embodiment, the Adaptive Disturbance and Health Estimator is implemented using an MPC architecture. Here, the MPC's dynamic model (502) is not of the entire system, but is a model of the unmodeled disturbance dynamics. The onboard optimizer (504) receives the residual error (the difference between measured state and baseline prediction) and, at each time step, solves an optimal control problem with a multi-objective cost function. A first objective is to find the corrective torque (part of 512) that best minimizes the future residual error. A second objective is to preserve vehicle health. This is achieved by incorporating the RUL estimates from the health module (600) as dynamic, health-informed constraints (508). These constraints, which include actuator saturation, are adjusted in real-time to, for example, reduce the allowable stress on a manipulator motor that has a low RUL.

### B. Implementation via Prognostic-Informed Deep Reinforcement Learning (RL)

Referring to FIG. 6, in another embodiment, the Adaptive Disturbance and Health Estimator is a Deep RL agent. The RL policy (602) (e.g., a deep neural network) is trained in a high-fidelity simulation (610) that includes unmodeled dynamics like propellant slosh. The policy's input state is expanded to include both the residual attitude error and its derivatives, and the current RUL estimates of vehicle components. The multi-objective reward function (612) is designed to penalize residual attitude error and simultaneously reward health preservation, implementing a health preservation objective that penalizes actions inducing high stress on components with a low RUL. The agent's action output is the holistically optimized corrective feed-forward command τ_{corrective}(t).

### End-to-End Self-Repair Protocol

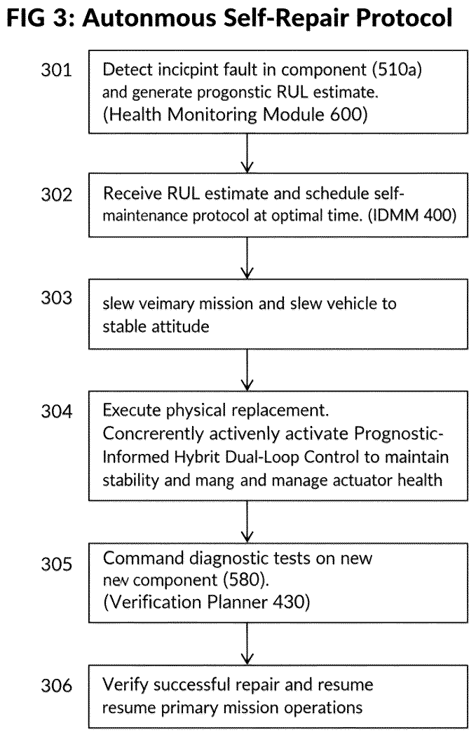

Referring to FIG. 3, an exemplary method is illustrated.

(301) the Health Monitoring Module (600) detects an incipient fault in a component (510a) and generates a prognostic RUL estimate for the component.

(302) the Intelligent Decision-Making Module (400) receives the RUL estimate and schedules the self-maintenance protocol at an optimal time.

(303) the vehicle ceases primary mission operations and slews to a stable attitude.

(304) the physical replacement is executed. The Manipulator Motion planner (420) generates and executes the planned motion. Concurrently, the prognostic-informed hybrid dual-loop control scheme is active: the Attitude & Orbit Control planner (410) commands the ACS (500) to apply the holistically optimized combined feed-forward command (baseline+corrective) to maintain high-precision stability against all disturbances, known and unknown, while managing the health of the actuators (e.g., the manipulator 550) performing the repair.

(305) a Verification Planner (430) commands diagnostic tests on the new component (580).

(306) upon successful verification, the module (400) commands the vehicle to resume primary mission operations.

What is claimed is:

1. A self-repairing autonomous orbital vehicle system, comprising:
a. a spacecraft bus configured for operation in a free-floating orbital environment;
b. a sensor suite disposed on the spacecraft bus and configured for attitude determination;
c. a health monitoring module configured to monitor a health status of a first hardware component of the system and, upon detecting an incipient fault in the first hardware component prior to a complete failure, to generate a structured prognostic fault signature comprising a quantitative prognostic estimate of a Remaining Useful Life (RUL) of the first hardware component;
d. a robotic manipulator coupled to the spacecraft bus;
e. a storage bay coupled to the spacecraft bus and configured to house a spare hardware component;
f. an attitude control system (ACS) configured to control an orientation of the spacecraft bus; and
g. an intelligent decision-making module communicatively coupled to the health monitoring module, the sensor suite, the robotic manipulator, and the ACS, the decision-making module configured to:
i. receive said structured prognostic fault signature and schedule an orbital self-repair protocol based on said RUL estimate; and
ii. in response, autonomously execute the orbital self-repair protocol, the protocol comprising:
(a) generating a planned motion for the robotic manipulator to physically replace the first hardware component with the spare hardware component;
(b) generating a baseline feed-forward command based on a kinodynamic model of the robotic manipulator, said baseline command calculated to cancel predictable disturbance torques induced by said planned motion;
(c) generating, concurrently with the execution of said planned motion, a corrective feed-forward command by:
(1) monitoring, via the sensor suite, a residual attitude error, wherein the residual attitude error is a difference between a measured attitude of the spacecraft bus and an expected attitude predicted by the kinodynamic model;
(2) processing said residual attitude error with an adaptive disturbance estimation module comprising a Model Predictive Control (MPC) optimizer to identify unmodeled disturbance torques not accounted for by the kinodynamic model; and
(3) calculating, via said MPC optimizer, the corrective feed-forward command by solving, at each time step, an optimal control problem to concurrently minimize a cost function based on a future predicted residual attitude error and satisfy a set of dynamic, health-informed constraints, said dynamic, health-informed constraints being adjusted in real-time based on said RUL estimate and including actuator saturation limits; and
(d) commanding the robotic manipulator to execute said planned motion while concurrently commanding the ACS to apply a combined feed-forward command comprising a sum of said baseline feed-forward command and said corrective feed-forward command, thereby actively canceling both predictable and unmodeled disturbance torques.

2. The system of claim 1, wherein the unmodeled disturbance torques are caused by one or more phenomena selected from the group consisting of: propellant slosh within tanks of the spacecraft bus, structural flexion of the spacecraft bus or the robotic manipulator, and a time-varying center of mass of the system as the spare hardware component is transported by the robotic manipulator.

3. The system of claim 1, wherein the planned motion is generated using a sampling-based motion planning algorithm selected from the group consisting of a Rapidly-Exploring Random Tree (RRT) algorithm and a Probabilistic Roadmap (PRM) algorithm.

4. The system of claim 1, wherein the intelligent decision-making module is further configured to, prior to executing the orbital self-repair protocol, cease a primary mission objective of the orbital vehicle.

5. The system of claim 1, wherein the intelligent decision-making module is further configured to, after the robotic manipulator has replaced the first hardware component, command a diagnostic test on the spare hardware component to verify a successful repair.

6. The system of claim 1, wherein the first hardware component is a reaction wheel assembly.

7. The system of claim 1, wherein the autonomous orbital vehicle is a deep-space probe configured for an interplanetary trajectory.

8. A self-repairing autonomous orbital vehicle system, comprising:
a. a spacecraft bus;
b. a sensor suite configured for attitude determination;
c. a health monitoring module configured to detect an incipient fault in a first hardware component prior to a complete failure and to generate a structured prognostic fault signature comprising a quantitative prognostic estimate of a Remaining Useful Life (RUL) of the first hardware component;
d. a robotic manipulator;
e. a storage bay housing a spare hardware component;
f. an attitude control system (ACS); and
g. an intelligent decision-making module configured to execute a self-repair protocol, the protocol comprising:
i. generating a planned motion for the robotic manipulator to replace the first hardware component with the spare hardware component;
ii. generating a baseline feed-forward command based on a kinodynamic model, said baseline command calculated to cancel predictable disturbance torques from said planned motion;
iii. generating a corrective feed-forward command by:
(a) monitoring a residual attitude error between a measured attitude from the sensor suite and an expected attitude from the kinodynamic model; and
(b) processing said residual attitude error with an adaptive disturbance estimation module comprising a Deep Reinforcement Learning (RL) policy, said RL policy being a deep neural network trained in a simulation environment to output the corrective feed-forward command in response to receiving an expanded state input, said expanded state input comprising both the residual attitude error and said RUL estimate; and
iv. commanding the ACS to apply a combined feed-forward command comprising a sum of said baseline feed-forward command and said corrective feed-forward command to cancel both predictable and unmodeled disturbance torques.

9. The system of claim 8, wherein the unmodeled disturbance torques are caused by one or more of: propellant slosh, structural flexion, or a time-varying center of mass.

10. The system of claim 8, wherein the simulation environment used to train the RL policy includes a high-fidelity model of unmodeled dynamics, and wherein the RL policy is trained using a multi-objective reward function that both penalizes residual attitude error and includes a health preservation objective that penalizes actions inducing stress on components associated with said RUL estimate.

11. A method for providing autonomous self-repair of a monolithic orbital vehicle, the method comprising:
a. detecting, via a health monitoring module, an incipient fault in a first hardware component prior to a complete failure and generating a structured prognostic fault signature comprising a quantitative prognostic estimate of a Remaining Useful Life (RUL) of the first hardware component;
b. in response, autonomously executing, via an intelligent decision-making module, an orbital self-repair protocol, the protocol comprising:
i. scheduling the orbital self-repair protocol based on said RUL estimate;
ii. generating a planned motion for a robotic manipulator to replace the first hardware component with a spare hardware component;
iii. generating a baseline feed-forward command based on a kinodynamic model, said baseline command calculated to cancel predictable disturbance torques induced by said planned motion;
iv. generating, concurrently with the execution of said planned motion, a corrective feed-forward command by:
(a) monitoring, via a sensor suite, a residual attitude error, said error being a difference between a measured attitude and an expected attitude predicted by the kinodynamic model;
(b) processing said residual attitude error with an adaptive disturbance estimation module comprising a Model Predictive Control (MPC) optimizer to identify unmodeled disturbance torques; and
(c) calculating, via said MPC optimizer, the corrective feed-forward command by solving, at each time step, an optimal control problem to concurrently minimize a cost function based on a future predicted residual attitude error and satisfy a set of dynamic, health-informed constraints, said dynamic, health-informed constraints being adjusted in real-time based on said RUL estimate and including actuator saturation limits; and
v. executing said planned motion with the robotic manipulator while concurrently commanding an attitude control system (ACS) to apply a combined feed-forward command comprising a sum of said baseline feed-forward command and said corrective feed-forward command, thereby actively canceling both predictable and unmodeled disturbance torques.

12. The method of claim 11, wherein the unmodeled disturbance torques are caused by one or more of: propellant slosh, structural flexion, or a time-varying center of mass.

13. The method of claim 11, wherein the protocol further comprises, after replacing the first hardware component, performing a diagnostic test on the spare hardware component and, upon successful verification, resuming a primary mission objective.

14. The method of claim 11, wherein the first hardware component is a reaction wheel assembly.

15. A method for providing autonomous self-repair of a monolithic orbital vehicle, the method comprising:
a. detecting an incipient fault in a first hardware component prior to a complete failure and generating a structured prognostic fault signature comprising a quantitative prognostic estimate of a Remaining Useful Life (RUL) of the first hardware component;
b. in response, executing a self-repair protocol, the protocol comprising:
i. scheduling the self-repair protocol based on said RUL estimate;
ii. generating a planned motion for a robotic manipulator to replace the first hardware component with a spare hardware component;
iii. generating a baseline feed-forward command based on a kinodynamic model to cancel predictable disturbance torques;
iv. generating a corrective feed-forward command by:
(a) monitoring a residual attitude error between a measured attitude and an expected attitude;
(b) processing an expanded state input with an adaptive disturbance estimation module comprising a Deep Reinforcement Learning (RL) policy, wherein said expanded state input comprises both said residual attitude error and said RUL estimate; and
(c) calculating, via said RL policy, the corrective feed-forward command, wherein the RL policy is a trained neural network that maps the expanded state input to the corrective feed-forward command action; and
v. commanding an attitude control system (ACS) to apply a combined feed-forward command comprising a sum of said baseline feed-forward command and said corrective feed-forward command.

16. The method of claim 15, wherein the RL policy is trained in a high-fidelity simulation that models unmodeled disturbances, including propellant slosh, and trained using a multi-objective reward function that includes a health preservation objective based on said RUL estimate.

17. The method of claim 15, wherein the first hardware component is selected from the group consisting of a reaction wheel assembly, a solar array drive mechanism, a radio frequency transponder, and any component designed as an orbit replaceable unit.
